(19) United States
(12) Patent Application Publication
(10) Pub. No.: US 2025/0231914 A1
(43) Pub. Date: Jul. 17, 2025

(54) MACHINE-LEARNING-BASED VISUAL FILE SYSTEM

(71) Applicant: Soot, Inc., San Francisco, CA (US)

(72) Inventors: Jacob Avi HARPER, Brooklyn, NY (US); Amol KAPOOR, Basking Ridge, NJ (US); Igor Emilian BRODECKI, Berlin (DE); Benjamin Siu Ming CHAN, London (GB); Noa Eisenbach CHAZAN, Philadelphia, PA (US); Malone Min CHEN, London (GB); Hunter John LARCO, New York City, NY (US); Mary NALLY, New York City, NY (US); Ganesh RAVICHANDRAN, Westbury, NY (US); Ilya SCHULTE, Oosterhout (NL); Thomas Rochus SCHWAIGER, Azóia (PT); Jochem Johannes VAN BRUGGEN, Harich (NL)

(73) Assignee: Soot, Inc., San Francisco, CA (US)

(21) Appl. No.: 18/412,036

(22) Filed: Jan. 12, 2024

(51) Int. Cl. G06F 16/16; G06F 16/14

(52) U.S. Cl. CPC G06F 16/168; G06F 16/148

(57) ABSTRACT

A method for displaying a graphical user interface of a file system for accessing a plurality of files can comprise receiving the plurality of files from a user, acquiring, for each file of the plurality of files, one or more representative digital objects associated with the file, providing the plurality of files to a trained machine learning model to generate a plurality of embeddings, obtaining a visual layout of the file system, arranging the plurality of embeddings based on the visual layout, and displaying the graphical user interface of the file system for accessing the plurality of files by rendering the representative digital objects associated with the plurality of files based on the arrangement of the plurality of embeddings.

### FIELD

The present disclosure relates generally to file systems, and particularly related to techniques (e.g., machine-learning techniques) for providing a visual file system.

### BACKGROUND

Graphical user interfaces (GUIs) of file systems allow users to view and access collections of files. Typically, such GUIs display lists of file names that can be sorted according to various basic file characteristics (e.g., creation date). Detailed insight into the data contained in a given file is not usually provided by the GUI. As a result, determining the contents of files stored in a file system frequently requires each file to be individually accessed. A user wishing to impose additional structure upon the display of the file system may be forced to manually organize files into folders. Even following extensive organization, the resulting presentation of the files on the GUI may not effectively communicate information about the files. Substantial effort and time on the part of a user may still be required if the user wants to familiarize themselves with the file system.

### SUMMARY

Described are techniques for providing a visual file system that leverage trained machine learning models to structure the file system. Using embeddings of the files in the file system in combination with a layout (e.g., a user-provided layout), the disclosed methods may produce a GUI that presents the file system in highly organized and informative manner that conforms to the user's aesthetic preferences. Files displayed using the resulting GUI may be automatically arranged according to the information they contain, allowing closely related files to be identified at a glance.

The methods disclosed herein may employ machine learning techniques in numerous ways. For example, trained machine learning models may be used to generate representative images of the files in the file system, even for files that do not include image data. These representative images may be rendered in the visual file system and may provide insight into the content of each file. Additional trained machine learning models may be used to generate embeddings for the files that are based in part on the representative images. The embeddings may allow the contents of each file to be compared and may be used to organize the displayed file system. Trained machine learning models can also be applied to generate metadata for each file. The machine-learning-generated metadata may allow the visual file system to be quickly reconfigured to display relevant files in response to specific information requests received from the user.

A variety of user controls and tools may be included in the visual file system, including a layout toggling tool that allows the user to cycle the structure of the file system between a set of visual layouts and a search tool that allows the user to cluster the files in the file system based on an user-inputted search query. These tools may provide the user with substantial aesthetic control over the visual file system and enable the user to efficiently explore and familiarize themselves with the file system.

The systems, methods, apparatuses, and non-transitory computer readable storage media provide numerous technical advantages. In various embodiments, the techniques disclosed herein may improve functioning of a computer by reducing processing power, battery usage, and memory requirements associated with displaying and exploring a visual file system. The visual file system may be easily explored, searched, and reorganized by users and may provide users with extensive insight into the information contained in the file system. The substantial aesthetic control over the layout of visual file system may be particularly useful for users who wish to share portfolios of creative works (e.g., artists sharing paintings or photographers sharing photographs) with others or online retailers who want to display their inventory in a visually interesting and easily navigable manner.

In a method for displaying a graphical user interface of a file system for accessing a plurality of files, the plurality of files may be received from a user. The plurality of files may include one or more image files, one or more text files, one or more audio files, one or more video files, or combinations thereof. For each file of the plurality of files, one or more representative digital objects associated with the file may be acquired. For each file of the plurality of files, the one or more representative digital objects associated with the file may comprise metadata associated with the file and/or one or more representative images associated with the file. The plurality of files may be provided to a trained machine learning model to generate a plurality of embeddings. A visual layout of the file system may be obtained, and the plurality of embeddings may be arranged based on the visual layout. The user input that is indicative of the visual layout can comprise an image that provides an outline of the visual layout or text describing the visual layout. The graphical user interface of the file system for accessing the plurality of files may be displayed by rendering the representative digital objects associated with the plurality of files based on the arrangement of the plurality of embeddings.

Acquiring the one or more representative digital objects associated with each file comprises providing one or more of the plurality of files to a second trained machine learning model to generate the one or more representative digital objects associated with the one or more files. If the digital objects comprise representative images, the one or more representative images associated with each file may include a first version of the representative image having a first resolution, a second version of the representative image having a second resolution, and a third version of the representative image having a third resolution.

In some embodiments of the method, the plurality of files is stored in a file store, the one or more representative digital objects associated with each file of the plurality of files are stored in a digital object store, and the plurality of embeddings is stored in an embedding store. Each file in the file store may be associated with one or more digital objects in the digital object store and one or more embeddings in the embedding store.

Arranging the plurality of embeddings may involve projecting each embedding of the plurality of embeddings into a two-dimensional vector space and organizing the plurality of embeddings based on the projections of each embedding. Rendering the representative digital objects may involve packing the representative digital objects into a shape corresponding to the visual layout using an image packing algorithm, which may require identifying one or more boundaries of the visual layout.

The method can further comprise receiving a search query from the user and displaying an updated graphical user interface by updating the render of the representative images based on the search query. A first file of the plurality of files that aligns with the search query may be identified by comparing the search query to metadata associated with each file of the plurality of files. One or more additional files of the plurality of files that align with the search query may be identified using the plurality of embeddings. The search query may indicate a color, a shape, an object, a date, or a location.

In some embodiments of the method, user input requesting that the visual layout of the file system be changed to a new visual layout may be received. An updated graphical user interface may be displayed in response to the received user input by updating the render of the representative images to the new visual layout.

The method can also comprise receiving a user request to share the file system with a second user. In response to the user request to share the file system, one or more datasets for the file system may be generated. The one or more datasets may be transmitted to the second user. The one or more datasets may be used to generate and display the graphical user interface for the file system on a remote computer system.

A system for displaying a graphical user interface of a file system for accessing a plurality of files may comprise one or more processors configured to receive the plurality of files from a user, acquire, for each file of the plurality of files, one or more representative digital objects associated with the file, provide the plurality of files to a trained machine learning model to generate a plurality of embeddings, obtain a visual layout of the file system, arrange the plurality of embeddings based on the visual layout, and display the graphical user interface of the file system for accessing the plurality of files by rendering the representative digital objects associated with the plurality of files based on the arrangement of the plurality of embeddings.

A non-transitory computer readable storage medium may store instructions for displaying a graphical user interface of a file system for accessing a plurality of files that, when executed by one or more processors of a computer system, cause the computer system to receive the plurality of files from a user, acquire, for each file of the plurality of files, one or more representative digital objects associated with the file, provide the plurality of files to a trained machine learning model to generate a plurality of embeddings, obtain a visual layout of the file system, arrange the plurality of embeddings based on the visual layout, and display the graphical user interface of the file system for accessing the plurality of files by rendering the representative digital objects associated with the plurality of files based on the arrangement of the plurality of embeddings.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The following figures show various graphical user interfaces of a file system as well as systems and methods for displaying said graphical user interfaces. The systems, methods, and graphical user interfaces shown in the figures may have any one or more of the characteristics described herein.

FIG. 1A shows a screenshot of a file system GUI displayed using the provided methods, according to some embodiments.

FIG. 1B shows an existing file system GUI, according to some embodiments.

FIG. 2 shows a method for displaying a GUI of a file system, according to some embodiments.

FIG. 3 shows an algorithm for generating embeddings, according to some embodiments.

FIG. 4 shows a diagram of a GUI of a file system displayed using the provided methods, according to some embodiments.

FIG. 5A shows an example of a user input that is indicative of visual layout.

FIG. 5B shows a screenshot of a file system GUI that has been rendered according to the visual layout shown in FIG. 5A.

FIG. 5C shows a screenshot of user controls in the file system GUI shown in FIG. 5B.

FIG. 6A shows a screenshot of a file system GUI with files displayed in a first visual layout.

FIG. 6B shows a screenshot of a file system GUI with files displayed in a second visual layout.

FIG. 6C shows a screenshot of a file system GUI with files displayed in a third visual layout.

FIG. 6D shows a screenshot of a file system GUI with files displayed in a fourth visual layout.

FIG. 6E shows a screenshot of a close-up view of a portion of the files displayed in the fourth visual layout shown in FIG. 6D.

FIG. 7A shows a screenshot of a file system GUI following receipt of an example user query.

FIG. 7B shows a screenshot of a file system GUI following receipt of another example user query.

FIG. 8A shows a screenshot of a file system GUI displaying example groupings of related files.

FIG. 8B shows a screenshot of a close-up view of a first grouping of related files shown in FIG. 8A.

FIG. 8C shows a screenshot of a close-up view of a second grouping of related files shown in FIG. 8A.

FIG. 9 shows a computer system, according to some embodiments.

### DETAILED DESCRIPTION

Described are systems, methods, apparatuses, and non-transitory computer readable storage media for providing a visual file system that leverage trained machine learning models to structure the file system. Using embeddings of the files in the file system in combination with a user-provided layout, the disclosed methods may produce a GUI that presents the file system in highly organized and informative manner that conforms to the user's aesthetic preferences. Files displayed using the resulting GUI may be automatically arranged according to the information they contain, allowing closely related files to be identified at a glance.

Various machine learning techniques may be employed by the disclosed systems, methods, apparatuses, and non-transitory computer readable storage media. Trained machine learning models may, for example, be used to generate representative images of the files in the file system, even for files that do not include image data (e.g., text files or audio files). These representative images may be rendered in the visual file system and may provide insight into the content of each file. Additional trained machine learning models may be used to generate embeddings for the files that are based in part on the representative images. The embeddings may allow the contents of each file to be compared and may be used to organize the displayed file system. Trained machine learning models can also be applied to generate metadata for each file. The machine-learning-generated metadata may allow the visual file system to be quickly reconfigured to display relevant files in response to specific information requests received from the user.

The provided visual file system can include numerous user controls and tools. These controls and tools may include a layout toggling tool that allows the user to cycle the structure of the file system between a set of visual layouts and a search tool that allows the user to cluster the files in the file system based on a user-inputted search query. In addition to allowing the user to control aesthetics of the visual file system (e.g., by changing the visual layout), the controls and tools may streamline the user's exploration of the file system.

The systems, methods, apparatuses, and non-transitory computer readable storage media provide numerous technical advantages. In various embodiments, the techniques disclosed herein may improve functioning of a computer by reducing processing power, battery usage, and memory requirements associated with displaying and exploring a visual file system. The visual file system may be easily explored, searched, and reorganized by users and may provide users with extensive insight into the information contained in the file system. The substantial aesthetic control over the layout of visual file system may be particularly useful for users who wish to share portfolios of creative works (e.g., artists sharing paintings or photographers sharing photographs) with others or online retailers who want to display their inventory in a visually-interesting and easily-navigable manner.

The following description sets forth exemplary methods, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

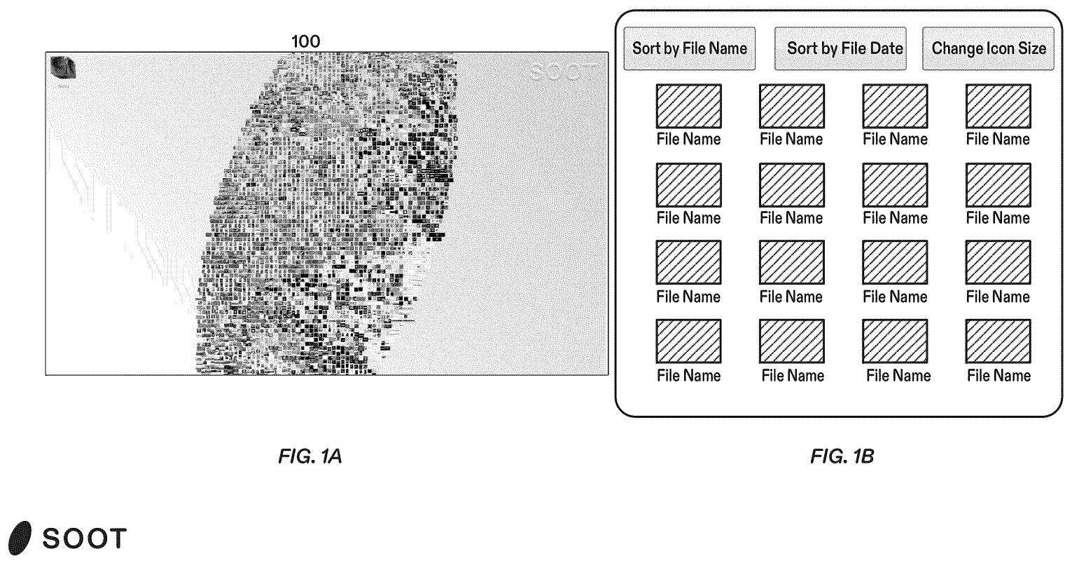

FIG. 1 provides a side-by-side comparison between a traditional file system GUI and an exemplary file system GUI rendered according to the techniques disclosed herein, in accordance with some embodiments. A screenshot of an example GUI 100 of a file system generated using the provided method is shown in FIG. 1A, and an illustration of a traditional file system GUI is shown in FIG. 1B. A user utilizing the traditional file system GUI may limited organizational control over the displayed file system. For example, the traditional file system GUI may allow the displayed files to be sorted only according to basic file data (e.g., file name, file creation date, etc.). While the traditional file system GUI may display images (e.g., icons) associated with each file, the images may convey little information about the files. Furthermore, the total number of files displayed at any given time is limited. As a result, gaining a comprehensive view of the file system may be challenging and time-consuming.

GUI 100, on the other hand, displays images associated with the files in the file system in a particular visual layout (in this example, an oval). This visual layout may be provided by a user (e.g., an owner of the file system). Within the visual layout, the files may be organized such that files containing similar information are closely clustered. The organization of the files within the visual layout combined with the compact presentation of the files may enable the user to gain insight into the contents of a large number of files in a short period of time. Machine-learning-based user controls provided in GUI 100 may allow the displayed file system to be searched and reorganized according to a myriad of parameters. The disclosed techniques therefore provide the user with significant aesthetic control over the manner in which the files are displayed while simultaneously supplying the user with valuable insight into the information contained in each file. As a result, the techniques described herein may be particularly useful for users who wish to share portfolios of creative works (e.g., artists sharing paintings or photographers sharing photographs) online or for online retailers who want to display their inventory in a visually-interesting and easily-navigable manner.

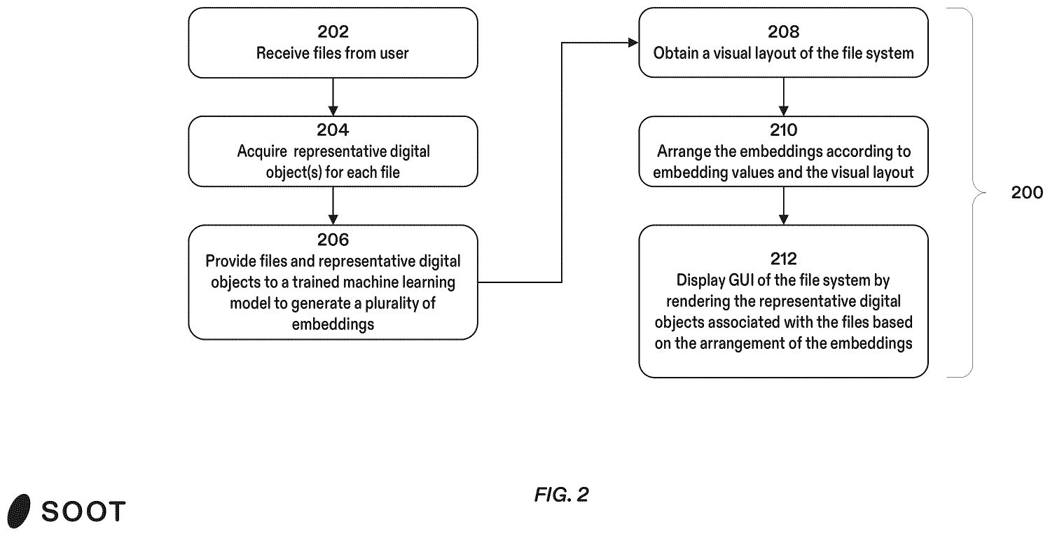

An exemplary method 200 for displaying a GUI of a file system is provided in FIG. 2. Method 200 may be executed by one or more processors of a computer system (e.g., a user's personal computer). Instructions that configure the processors to perform method 200 may be stored in the computer system's memory or using a computer readable storage medium. One or more steps of method 200 may be carried out automatically, for example upon receipt of necessary user input. Method 200 may be performed, for example, using one or more electronic devices implementing a software platform. In some examples, method 200 is performed using a client-server system, and the blocks of method 200 are divided up in any manner between the server and a client device. In other examples, the blocks of method 200 are divided up between the server and multiple client devices. In other examples, method 200 is performed using only a client device or only multiple client devices. In method 200, some blocks are, optionally, combined, the order of some blocks is, optionally, changed, and some blocks are, optionally, omitted. In some examples, additional steps may be performed in combination with the method 200. In some examples, one or more blocks of method 200 are reordered. Accordingly, the operations as illustrated (and described in greater detail below) are exemplary by nature and, as such, should not be viewed as limiting.

In a first step 202, a plurality of files of a file system may be received by the computer system from a user. The plurality of files can be of one or more file formats, including image file formats (e.g., JPEG, PNG, GIF, SVG, etc.), video file formats (Windows Media Video, AVI, QuickTime, etc.), audio file formats (MP3, MP4, etc.), text file formats (plain text, real text, Microsoft Word documents, spreadsheets, HTML, etc.), and multimedia file formats. Additionally, the plurality of files can include files of a multitude of file sizes, ranging from about (or smaller than) 1 KB to about (or greater than) 5 GB. In some embodiments, the total number of files may exceed 100,000.

After the files have been received from the user, one or more representative digital objects may be acquired for each file (step 204). The representative digital object(s) associated with a file may comprise data objects that indicate or describe the information contained in the file. For example, the representative digital object(s) associated with a file may include an image that describes or is generated based on the information contained in the file, text that describes the information contained in the file, audio that describes or is generated based on the information contained in the file, or video that describes or is generated based on the information contained in the file. Representative digital object(s) associated with a file can be provided by a user or acquired automatically by the computer system. For example, representative digital object(s) for a file may be generated by providing the file to one or more generative artificial intelligence models.

In some embodiments, the representative digital object(s) acquired for each file comprise representative image(s) associated with the file. The representative image(s) associated with a file may indicate the information contained in the file. All of the representative images may be encoded using the same file format (e.g., each the representative image may be a PNG). The process for acquiring the representative image(s) for a given file may vary depending on the file format of said file. If a file is an image file, generating the representative image(s) associated with the file may involve copying the file and subsequently converting the file copy to the appropriate file format. For example, if the image file is a JPEG file, and the file format for the representative images is PNG, acquiring the representative image(s) associated with the file may involve copying the file and then converting the file copy from a JPEG file to a PNG file. If a file is a video file, acquiring the representative image(s) associated with the file may involve taking screenshots of one or more frames of the video and then (if necessary) converting the screenshots to the appropriate file format. Acquiring the representative image(s) associated with a text file may be a similar process: one or more screenshots of the text file may be taken and, if required, converted into the appropriate file format. If the file is an audio file, acquiring the representative image(s) associated with the audio file may involve generating a visualization of the properties of the audio, for example by generating an image based on a Fourier transform of the audio. A representative image for a file can also be produced by providing the file to a generative artificial intelligence model that can ingest the file and output an image based on the data contained in the file.

The representative images associated with each file include multiple versions of the same image. In some embodiments, at least 2, at least 3, at least 4, at least 5, or at least 10 versions of a representative image are acquired for each file. Each version of the representative image for a given file may have a different resolution. For example, if the representative images associated with a given file include four versions of the same image, the first version of the representative image may be 32 pixels in width and 32 pixels in height (i.e., may be 32×32), the second version may be 256×256, the third version may be 924×924, and the fourth version may be 2046×2046.

Additionally or alternatively, the representative digital object(s) associated with a file can include metadata associated with the file. The metadata may be ingested by the computer system (e.g., may be input into the computer system by the user) or, in some embodiments, extracted from each file by the computer system. The metadata associated with a given file may include (but is not limited to) the file name, the file creation date, the file creation time, the date and/or time of the most recent edits to the file, the file size, information about the device that created the file (e.g., for an image file storing a photograph, information about the camera that captured the photograph), geolocation data associated with the file (e.g., for an image file storing a photograph, geolocation data indicating the location at which the photograph was taken), or combinations thereof. The metadata associated with a given file can also include user-generated captions or descriptions summarizing the information contained in each file. For audio files (or video files that include audio data), metadata may include transcriptions of speech (e.g., transcriptions of lyrics or transcriptions of dialogue) or descriptions of sounds. For image or video files, metadata may include descriptions or labels of objects, people, animals, locations, or colors included in the image or video.

Following the production of the representative digital objects, the plurality of files and, in some embodiments, one or more of the representative digital object(s) associated with each file may be used to generate a plurality of embeddings (step 206). The embeddings may be vectors that represent the files and may be generated using any algorithm that can receive the files and/or the representative digital objects as an input and produce vectors of numeric values (e.g., floating values) as an output. In some embodiments, the embeddings are precalculated (e.g., calculated prior to the execution of further steps in method 200 and stored to be accessed as needed). In other embodiments, the embeddings are calculated in real time as they are needed (e.g., as they are needed in subsequent steps of method 200).

Each file may be associated with one or more embeddings. In some embodiments, one or more embeddings are generated for each representative digital object associated with a file. For example, if the representative digital objects for a file include a representative image, metadata indicating a file type, and metadata comprising keywords associated with the information contained in the file, then the embeddings associated with the file may include an embedding for the representative image, an embedding for the file type, and an embedding for the keywords associated with the information contained in the file.

As noted, the embeddings may be produced using any algorithm that can produce a vector of numeric values (e.g., floating values) from a file and/or a representative image. For example, the embeddings may be vectors of dominant RGB values in the representative images that are produced using an algorithm configured to calculate the dominant RGB values from an image. A trained machine learning model may also be used to produce the embeddings.

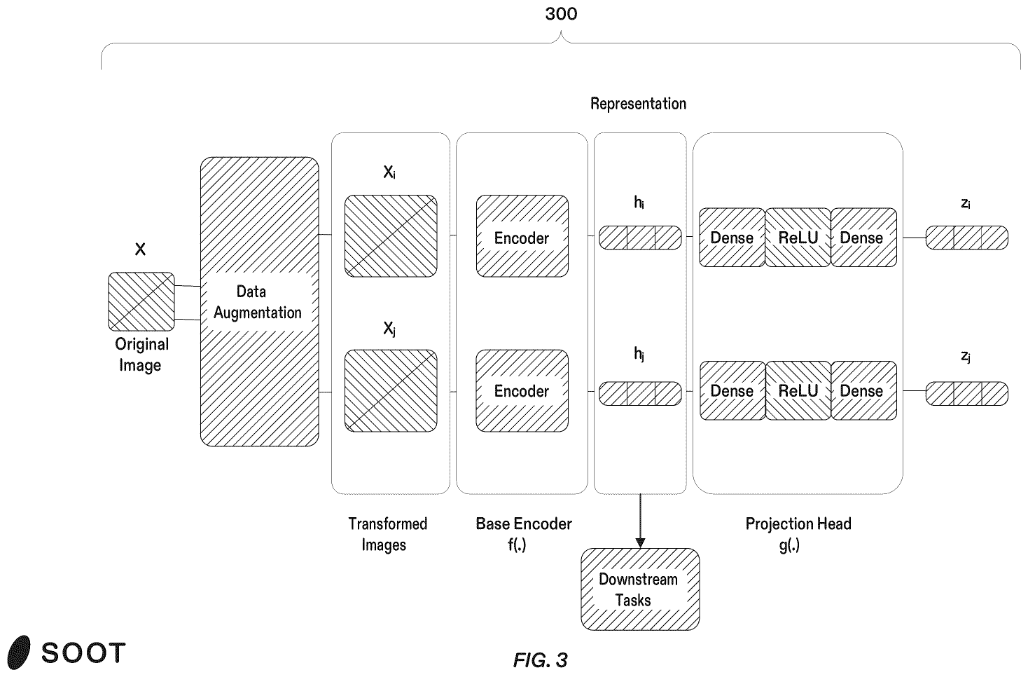

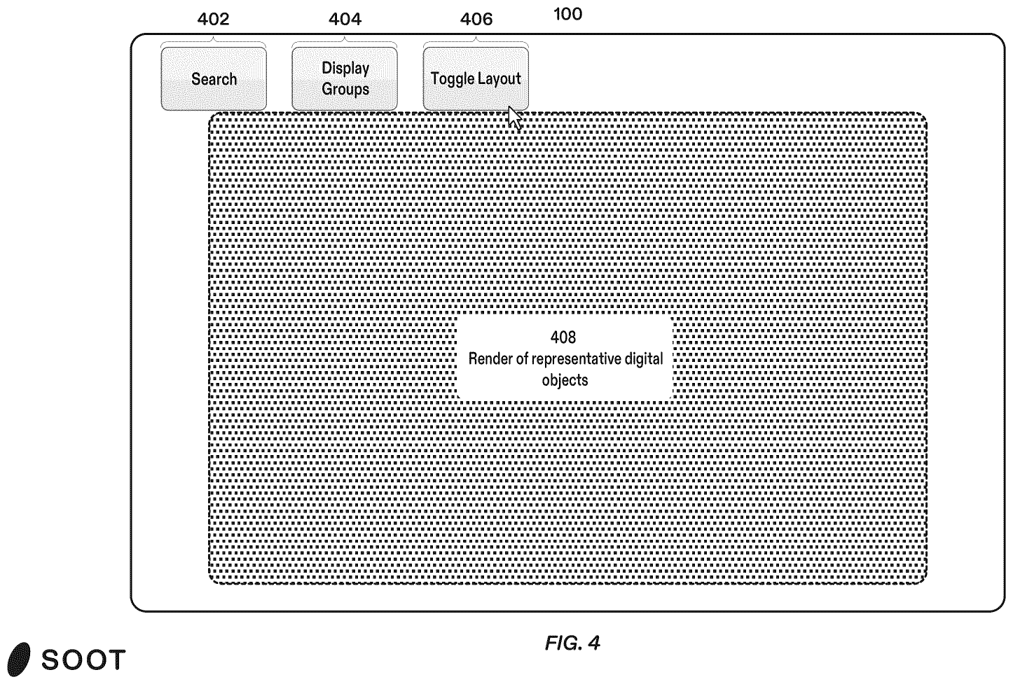

A trained machine learning model can also be used to generate the plurality of embeddings. FIG. 3 illustrates a training process 300 for an exemplary contrastive learning algorithm that may be used to generate embeddings in step 206 of method 200. During training, an original image X is obtained. Data transformation or augmentation can be applied to the original image X to obtain two augmented images Xᵢ and Xⱼ. For example, two separate data augmentation operators (e.g., crop, flip, color jitter, grayscale, blur, etc.) can be randomly applied to the original image X to obtain Xᵢ and Xⱼ. Each of the two augmented images Xᵢ and Xⱼ may then be passed through an encoder to obtain respective vector representations in a latent space. The two encoders may have shared weights. In some examples, each encoder is implemented as a neural network. For instance, an encoder can be implemented using a variant of the residual neural network (“ResNet”) architecture.

The encoders may output a vector hᵢ from augmented image Xᵢ and a vector hⱼ from the augmented image Xⱼ. The two vector representations hᵢ and hⱼ may be passed through a projection head to obtain two projections, zᵢ and zⱼ. In some examples, the projection head comprises a series of non-linear layers (e.g., a dense layer, followed by a ReLU layer, followed by a dense layer) that apply non-linear transformations to the vector representation to obtain the projection. The projection head may amplify invariant features and maximize the ability of the network to identify different transformations of the same image.

The files, representative digital objects, and embeddings may be stored in a set of data stores. For example, the plurality of files may be stored in a file store, the representative digital objects may be stored in a digital objects data store (or in multiple digital object data stores, if each file has multiple associated representative digital objects), and the plurality of embeddings may be stored in an embedding store. Each file in the file store may be associated with one or more of the digital objects in the one or more digital object data stores. For example, each file in the file store may be associated with an image in a representative image data store and associated with metadata in a metadata store. Each file in the file store may also be associated with one or more embeddings in the embedding store. This may allow, e.g., a representative digital object in a digital object store to be mapped to a file in the file store which, in turn, may be mapped to one or more embeddings in the embedding store.

The representative digital objects and the embeddings may be acquired and/or generated at any state of method 200. To create a representative image for an audio file, for example, the audio file may be embedded in a joint audio-image embedding space. An embedding of an image may be identified based on the embedding of the audio file, for example by determining the image embedding that is closest in the joint audio-image embedding space to the embedding of the audio file. This image embedding may be used to identify a representative image for the audio file.

Returning to FIG. 2, in addition to generating an embedding for each file (step 206 of method 200), the computer system that is executing method 200 may obtain a visual layout (step 208). The visual layout may be an intended layout for the displayed file system and may comprise patterns configured to reveal important relationships among the displayed files. The patterns in a visual layout can be determined based on the plurality of embeddings, based on user input, based on a library of predetermined layouts, default settings, or based on digital objects associated with the plurality of files. Examples of visual layouts include (but are not limited to) two-dimensional shapes (e.g., circles, ellipses, triangles, squares, rectangles, trapezoids, pentagons, etc.), three-dimensional shapes (e.g., spheres, ellipsoids, pyramids, cubes, prisms, etc.), letters (in any alphabet), number, outlines of objects, outlines of animals, and outlines of plants. In some embodiments, a visual layout includes multiple layout features, for example combinations of letters or combinations of shapes. In some embodiments, the user may provide several (e.g., more than one) visual layouts.

In some embodiments, the visual layout is obtained from a user input that indicates the visual layout. The user input that indicates the visual layout may comprise an image of the visual layout. For example, the user input may comprise a black-and-white image that depicts a silhouette of the visual layout in black against a white background (or vice versa). Additionally or alternatively, the user input that indicates the visual layout may include a text description of the visual layout. If, for instance, the user's desired visual layout is an oval, the user input that indicates the visual layout may include the string “oval”. The text description of a visual layout can also include, e.g., description of relevant dimensions in the layout or description of the layout's orientation. In some embodiments, the user selects a desired visual layout from a database of visual layouts that is stored by the computer system. The user input that indicates the visual layout can also be a mathematical function that defines the visual layout.

In some embodiments, the computer system automatically determines the visual layout. The visual layout may be automatically determined using a trained machine learning model or may be selected by the computer system from a library of visual layouts. The computer system may be configured to automatically determine the visual layout if no user input indicating a visual layout is provided. For example, if user input indicating a visual layout is not provided, a default visual layout from a library of visual layouts may be automatically selected.

After the embeddings for the files are generated and the user input indicating the visual layout is received, the embeddings may be arranged (step 210). Arranging the embeddings may comprise organizing the embeddings based on their relative positions in the vector space that contains the embeddings. The separation distance between two embeddings in the vector space or latent space (where said distance is given, e.g., by a metric induced by a norm of the vector space) may correspond to a degree of similarity of the information contained in the files represented by the embeddings. That is, a pair of files represented by two embeddings that are separated by a distance d₁ in the vector space may be more similar to one another than another pair of files represented by two embeddings that are separated by a distance d₂>d₁. The embeddings may be arranged such that each embedding is grouped or associated with other embeddings with which it is closely related. If the vector space that contains the embeddings is large (e.g., if the dimension of the vector space is greater than or equal to three), then the embeddings can projected into a two-dimensional vector space (using, e.g., a U-map model) and subsequently arranged based on the relative positions of the two-dimensional projections. Once the embeddings are clustered according to their values, each embedding may be assigned a position that corresponds to a point in the visual layout.

Once the embeddings are arranged, a graphical user interface (GUI) may be displayed by rendering the representative digital objects associated with each file based on the arrangement of the embeddings (step 212). Rendering the representative digital objects may involve packing the digital objects (e.g., the representative images) into the geometric outline or shape indicated by the provided visual layout. To pack the images into the visual layout, the boundaries or outlines of the visual layout may be identified. The representative digital objects may be packed within the boundaries of the geometric outline or shape using a shape packing optimization algorithm that divides the geometric outline or shape into a plurality of containers or bins (e.g., two-dimensional convex regions) and then packs the representative digital objects into the plurality of containers or bins according to one or more predetermined packing rules (e.g., rules indicating a maximum packing density, that there should be no overlap between the digital objects, etc.). The shape packing algorithm may be augmented using the plurality of embeddings to ensure that similar or related files are closely grouped within the geometric outline or shape.

A diagram of an exemplary GUI 100 that is displayed using the described method (e.g., method 200) is illustrated in FIG. 3. As shown, GUI 100 may comprise a render 408 of the representative images associated with the plurality of files. Render 408 may depict the representative images arranged according to the visual layout that was indicated by the user. GUI 100 may allow the user to zoom in or zoom out on any region of render 408. As the user zooms in or zooms out, different versions of each representative image may be displayed. For example, as the user zooms in, render 408 may be updated such that higher resolution versions of the representative images that are packed into the region of the visual layout on which the user is focusing are displayed.

In addition to render 408, GUI 100 may include a plurality of user controls. For example, GUI 100 may comprise a search control 402 configured to allow a user to search and cause GUI 100 to display representative images of files that align with a given search query. In addition, GUI 100 can include a group display control 404 configured to cause render 408 to show the clusters of representative images representing closely related files in an “unpacked” state (e.g., to show the clusters without also arranging the clusters to form the visual layout). If multiple visual layout options are available (e.g., if the user provided multiple visual layouts in step 208 of method 200, or if the computer system has a set of stored visual layouts in addition to any visual layouts provided by the user), GUI 100 may also include a layout toggling control 406 configured to change the visual layout of the representative images in render 408.

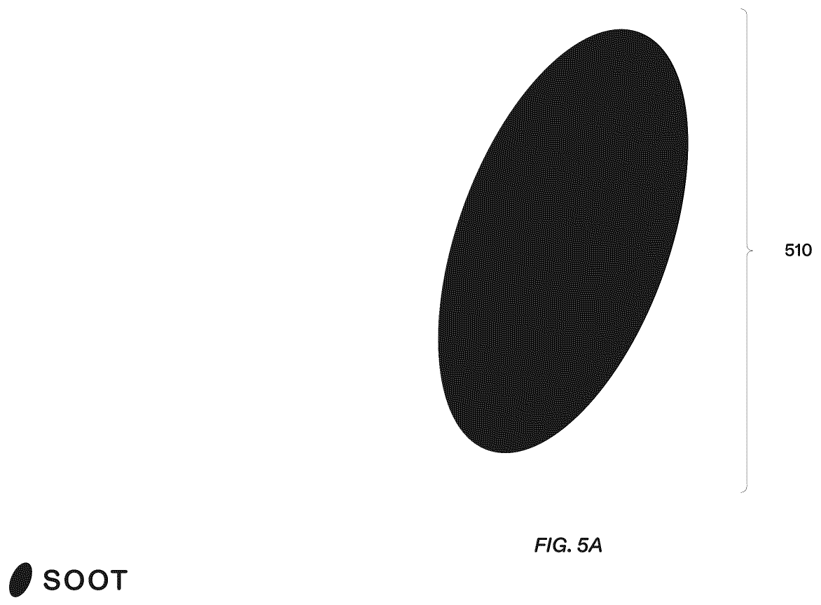

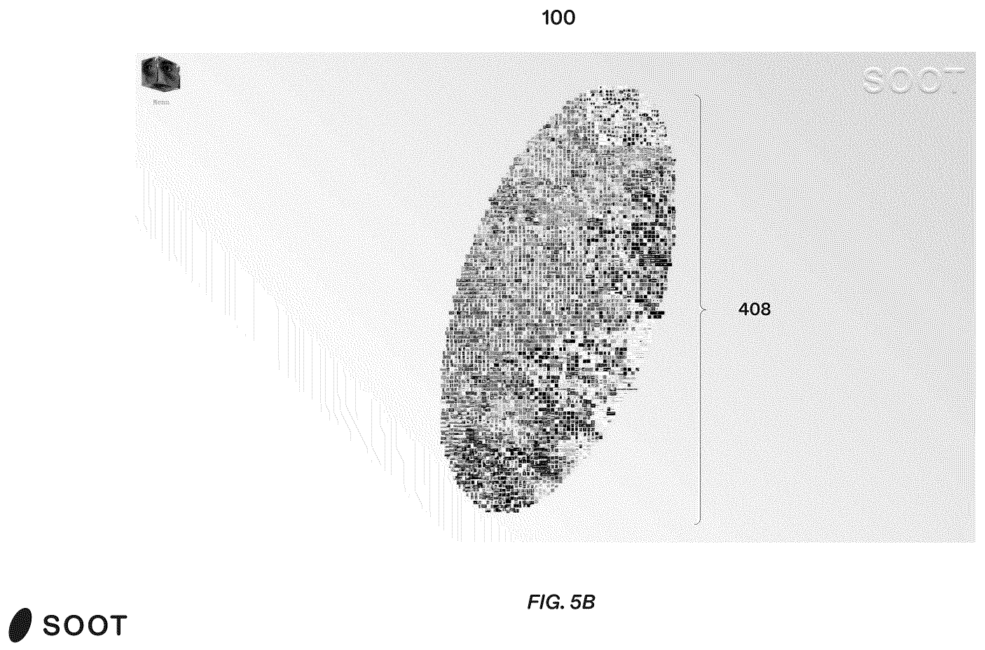

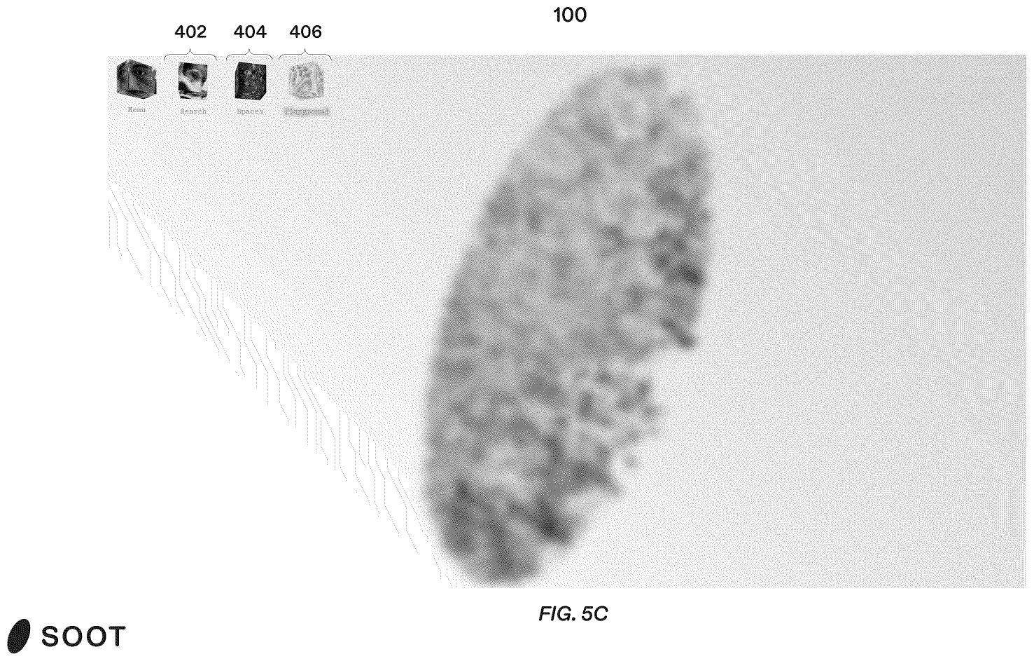

An example user input indicating a visual layout 510 is shown in FIG. 5A. FIG. 5B shows a screenshot of an exemplary implementation of GUI 100 comprising a render 408 of the representative images wherein the representative images are arranged according to visual layout 510. A search control 402, a group display control 404, and a layout toggling control 406 of GUI 100 are shown in FIG. 5C.

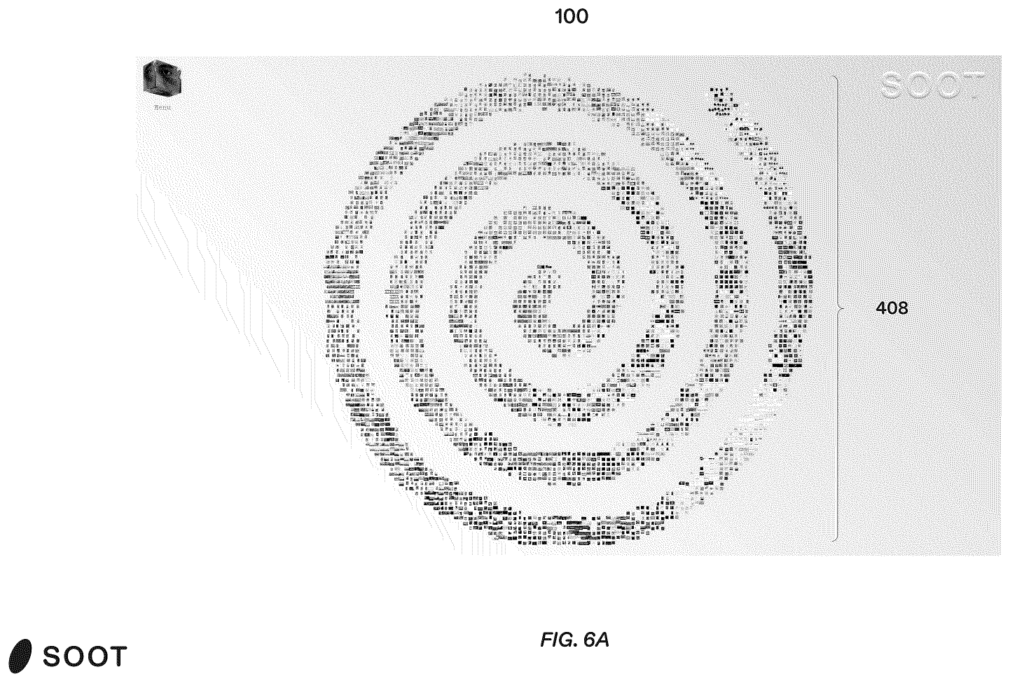

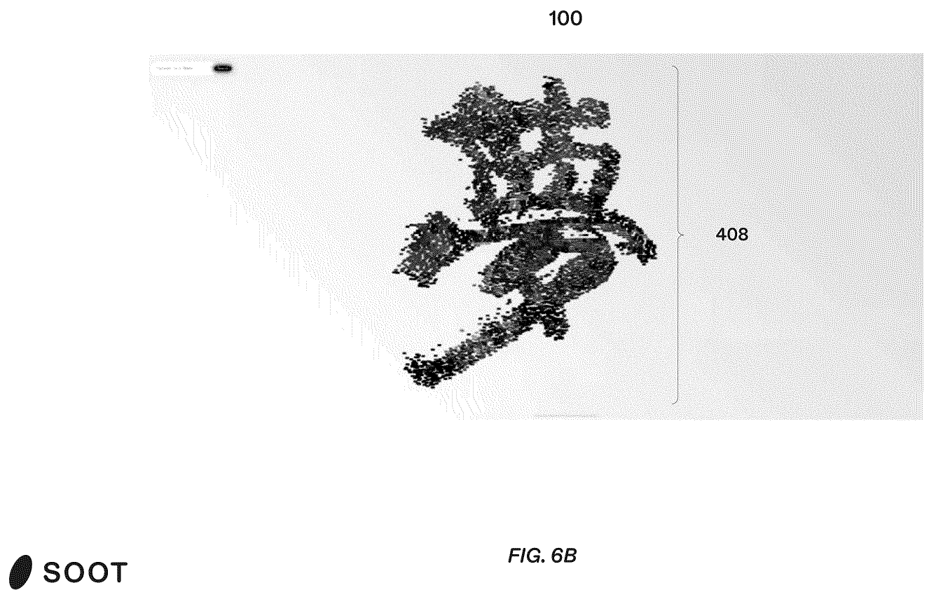

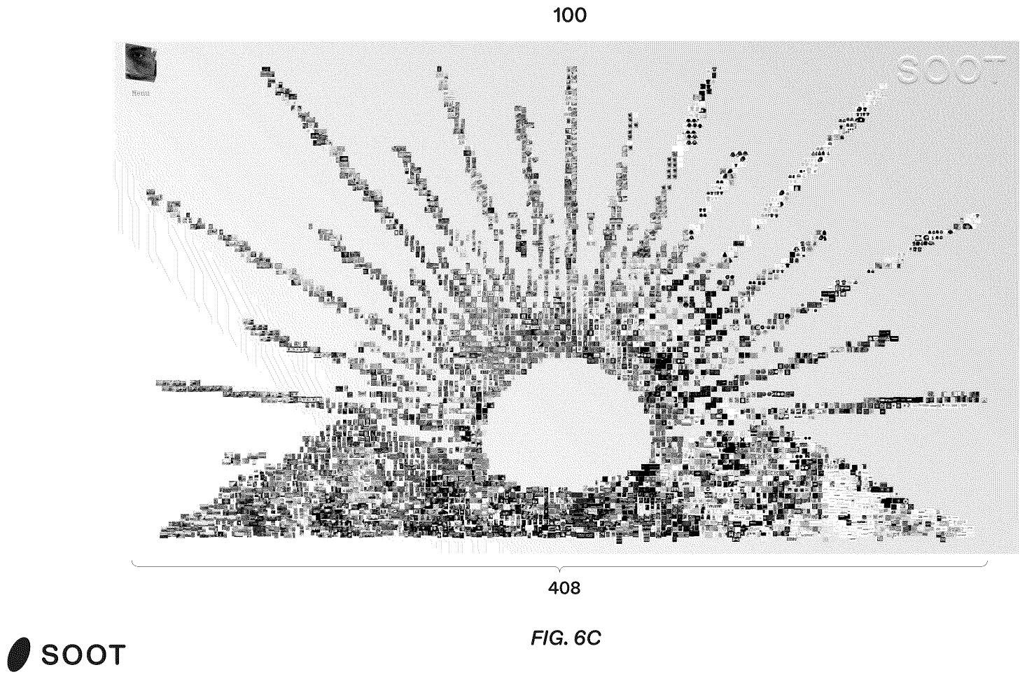

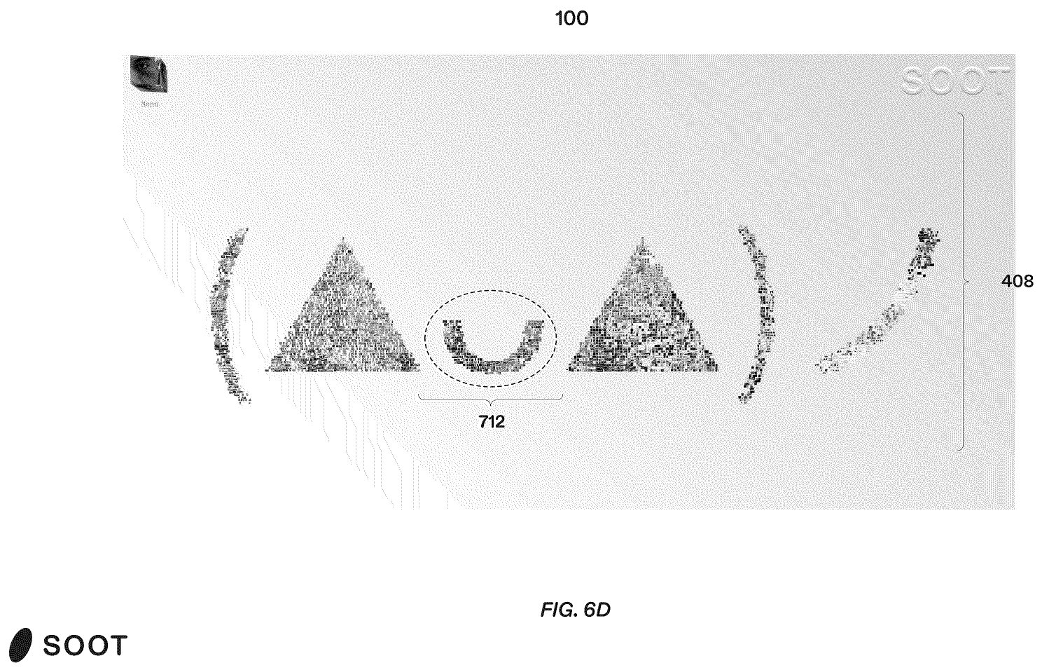

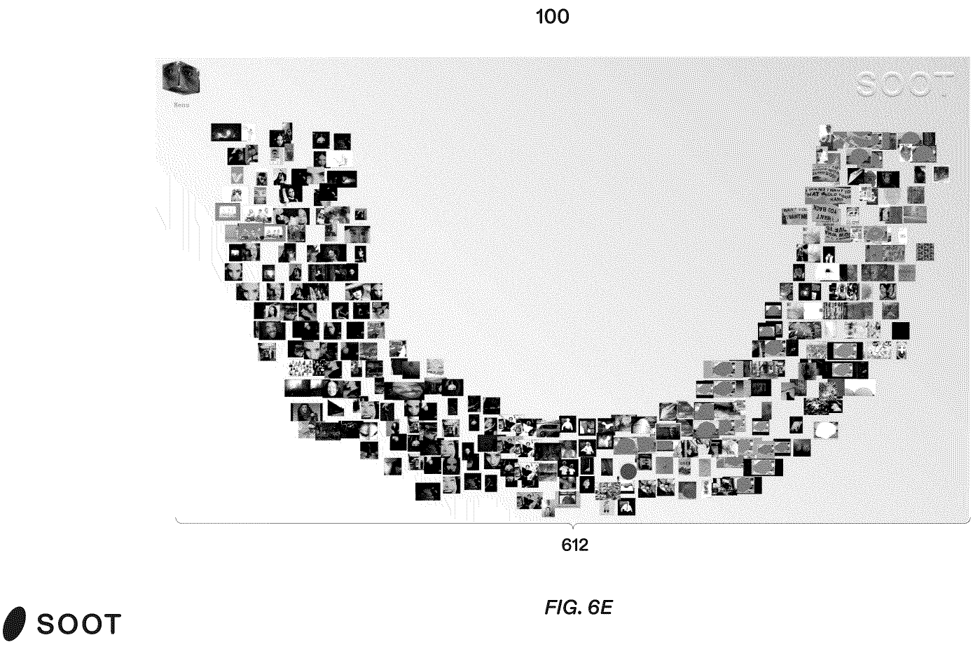

Using layout toggling control 406, a user may switch render 408 of the representative images between a plurality of visual layouts. Example visual layouts are shown in FIGS. 6A-6D. As previously noted, representative images of closely related files (e.g., files that contain similar information) may be packed closer to one another in the visual layout than representative images of files that are not closely related (e.g., files that contain dissimilar information).

Zooming in on a particular region of render 408 (e.g., region 612 of render 408 shown in FIG. 6D) may allow the user to view clusters of representative images of similar files in higher resolution, as shown in FIG. 6E. Using GUI 100 may, therefore, help the user to efficiently identify related files in a file system while providing the user with visual indications (via the representative images of the files) of the information contained in each file.

The computer system that displays GUI 100 may utilize texture atlases to efficiently update render 408 as the user zooms in and out. When the user is zoomed out, the texture atlases may comprise hyper-compressed versions of the representative images; as the user zooms in on a particular region of render 408, the compressed versions of the representative images in the region that are contained in the texture atlas may be replaced by higher resolution versions of the same images.

In many cases, files in a file system that are similar in some aspects may be dissimilar in other aspects. For example, two photographs that were captured using the same camera may depict different subjects. Search control 402 may allow a user to input a search query and, upon receipt of the search query, may update render 408. The computer system may update render 408 by searching the file store, the digital objects store, and/or the embedding store to identify files that closely match or align with the search query. For example, the computer system may, upon receipt of a search query, search stored digital objects (e.g., stored metadata) associated with the plurality of files to identify a first file that aligns with the search query. After the first file has been identified, additional files that align with the search query may be identified based on the plurality of embeddings. For example, the additional files that align with the search query may be identified by locating one or more embeddings of the plurality of embeddings that are, e.g., within a threshold separation distance in the vector space (or in a lower-dimensional projection space) of an embedding associated with the first file and identifying the files that correspond to said one or more embeddings. The first file and the one or more additional files may then be displayed.

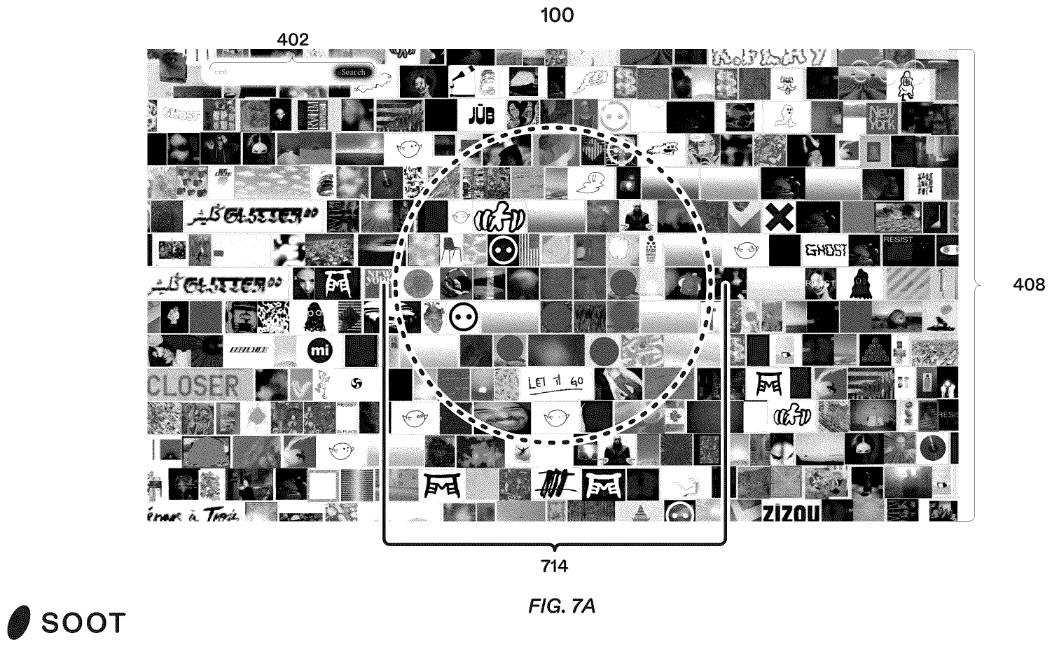

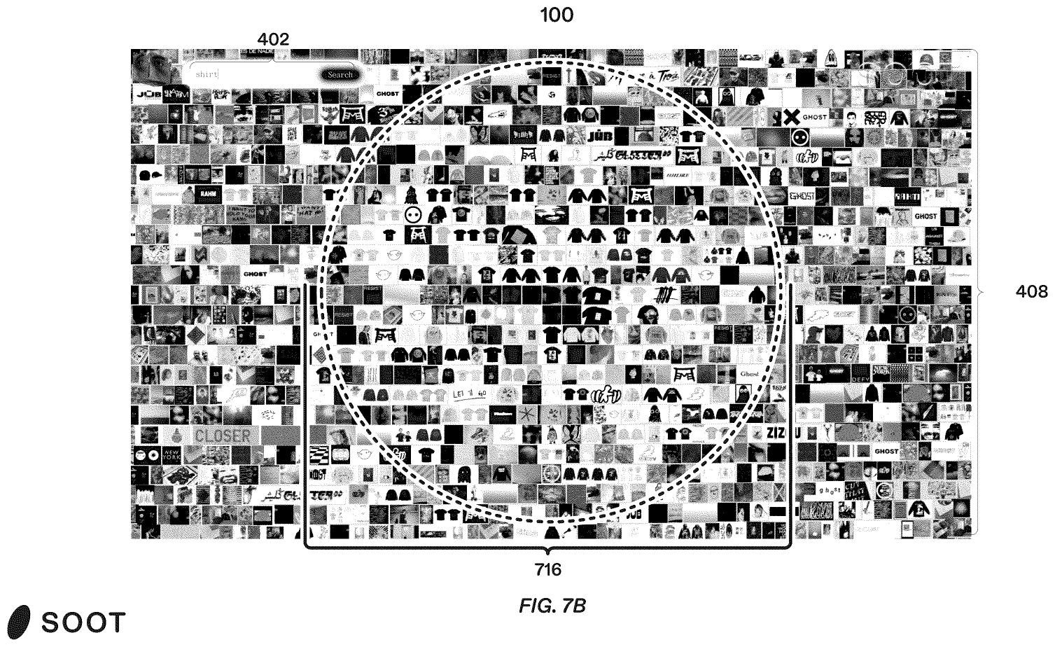

As shown in FIGS. 7A-7B, when render 408 is updated in response to a search query, representative images of files that align closely with the search query may be displayed in a particular region of the display screen (e.g., proximate to the center of the display screen). As the distance from this region increases in the updated render 408, the density of representative images of files that align closely with the search query may decrease. For example, as shown in FIG. 7A, inputting the search query “red” into search control 402 may update render 408 such that representative images of files that contain high levels of the color red are clustered in and around a region 712. Similarly, as shown in FIG. 7B, inputting the search query “shirt” into search control 402 may update render 408 such that representative images of files that containing information about shirts and similar clothing items are clustered in and around a region 714.

As described, the visual layout of the GUI, particularly following a search, may be configured to reveal important relationships among the plurality of files. In some embodiments, the visual layout comprises one or more abstract shapes or patterns defined by one or more axes. Each axis may be related to a specific type of file data (e.g., time/date of file creation, colors, objects, or topics depicted or referenced in the file, etc.). This may allow a user to simultaneously perform, e.g., several nearest neighbor searches along several axes for a given file. For example, for an image file containing a photograph of a dog, a user may perform nearest neighbor searches along axes such as “animals”, “date of file creation”, and “geographic location”. The results of the searches may be the nearest neighbor files along each search axis to the initial file containing the photograph of the dog. The results may be arranged in a visual layout that allows the user to identify the results of each distinct search. For example, the nearest neighbor files along the “animals” search axis may be grouped together in a first pattern while the nearest neighbor files long the “date of file creation” search axis may be grouped together in a second pattern.

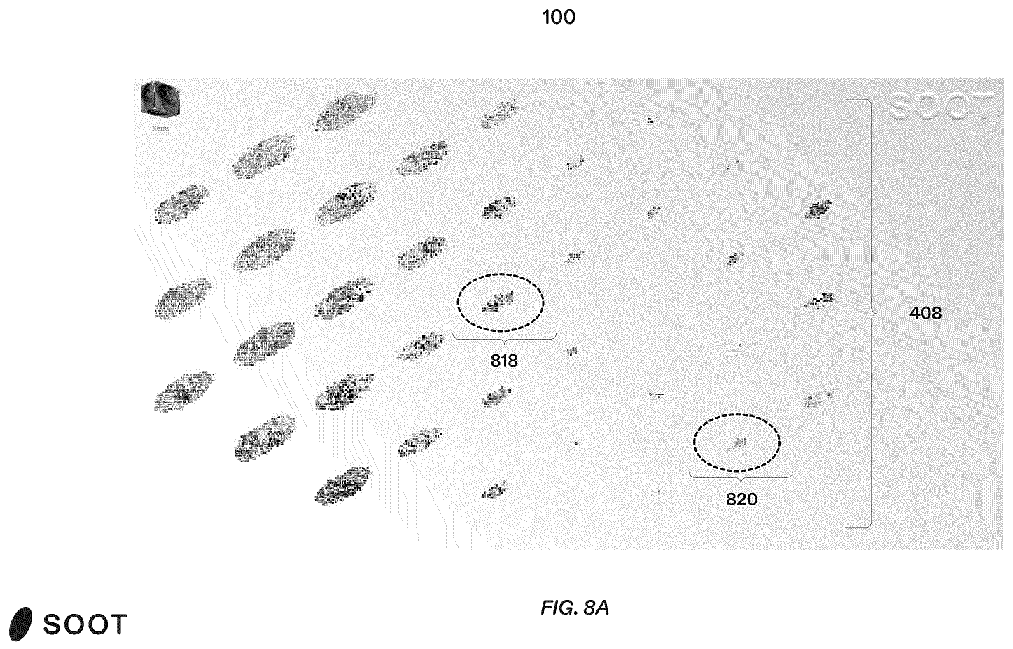

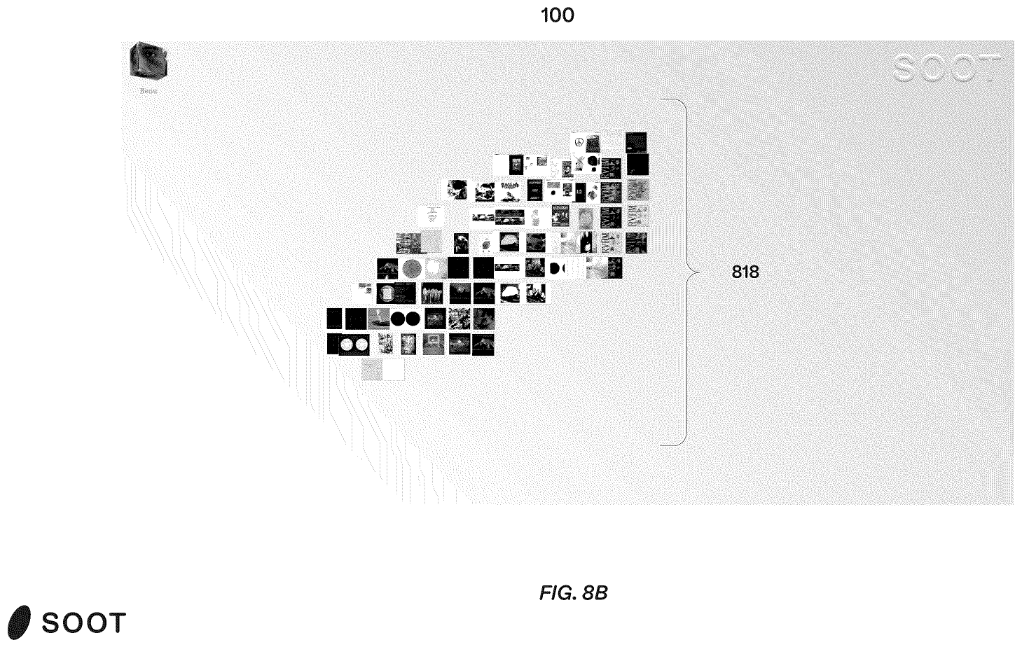

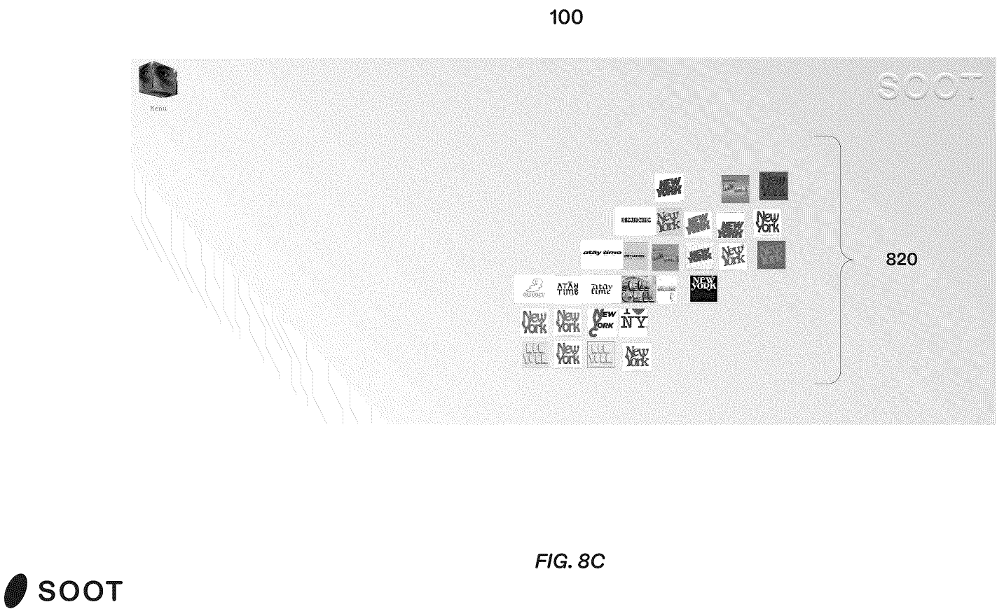

Group display control 404, as discussed, may be configured to cause render 408 to show the clusters of representative images representing closely related files in an “unpacked” state where the representative images are not packed into a visual layout. An example of an updated render 408 that results from the use of group display control 404 is shown in FIG. 8A. In this view, the user may quickly assess the sizes of each group of related files based on the size of each cluster of representative images. Zooming in on a cluster of representative images (e.g., cluster 818 or cluster 820) may provide the user with higher resolution view of the representative images in the cluster, thereby allowing the user to determine the information that is shared among or similar between the files represented by each image in the cluster (see FIG. 8A and 8B, respectively, for screenshots of close-up views of clusters 818 and 820).

A GUI of a file system (e.g., GUI 100) can include one or more additional user tools or controls that enable the user to explore and organize the visual file system. These tools may include a mass editing tool that allows two or more files (or the representative digital objects associated with said files) to be edited simultaneously. Such a tool may allow the user to perform the same operation on several files at the same time. For example, the mass editing tool may allow the user to crop several selected image files to the same size, or to add the same text tag to a set of selected files.

The GUI may also include a file sharing tool that allows users to share their file system (or portions of their file system) and the underlying organizational structure of the file system (generated, e.g., using method 200). A user may input a request to share their file system with a second user using the file sharing tool. The second user may be associated with a remote computer system (that is, a computer system distinct from the computer system used to, e.g., execute method 200). Upon receipt of the user request to share the file system, one or more datasets for the file system may be generated. The datasets for the file system may include, e.g., the file store storing the plurality of files (or a subset of said file store), the digital object store(s) storing the representative digital objects associated with the plurality of files (or subset(s) thereof), the embedding store storing the plurality of embeddings (or a subset of said embedding store), or combinations thereof. These datasets may be transmitted (e.g., wirelessly) to the remote computer system to generate and display a file system GUI identical to the sharer's file system GUI.

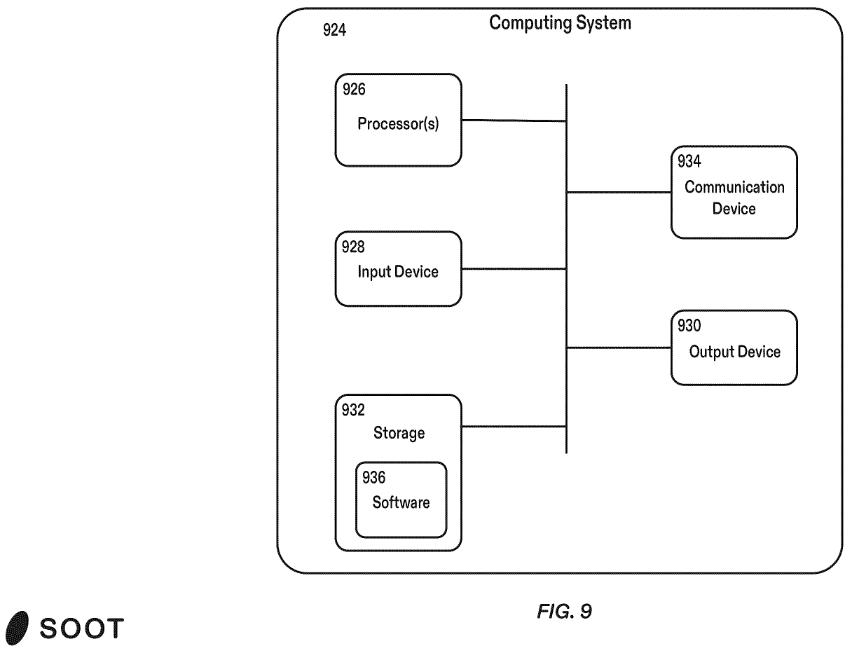

FIG. 9 shows an exemplary computer system 924 that can be used to execute the described method (e.g., method 200) for displaying a GUI of a file system (e.g., GUI 100). Computer system 924 can be any suitable type of microprocessor-based device, such as a personal computer, workstation, server, or handheld computing device (portable electronic device) such as a phone or tablet, or dedicated device. As shown in FIG. 9, computer system 924 may include one or more classical (binary) processors 926, an input device 928, an output device 930, storage 932, and a communication device 934.

Input device 928 and output device 930 can be connectable or integrated with system 102. Input device 928 may be any suitable device that provides input, such as a touch screen, keyboard or keypad, mouse, or voice-recognition device. Likewise, output device 930 can be any suitable device that provides output, such as a display, touch screen, haptics device, or speaker.

Storage 932 can be any suitable device that provides (classical) storage, such as an electrical, magnetic, or optical memory, including a RAM, cache, hard drive, removable storage disk, or other non-transitory computer readable medium. Communication device 934 can include any suitable device capable of transmitting and receiving signals over a network, such as a network interface chip or device. The components of computer system 924 can be connected in any suitable manner, such as via a physical bus or via a wireless network.

Processor(s) 926 may be or comprise any suitable classical processor or combination of classical processors, including any of, or any combination of, a central processing unit (CPU), a field programmable gate array (FPGA), and an application-specific integrated circuit (ASIC). Software 936, which can be stored in storage 932 and executed by processor(s) 926, can include, for example, the programming that embodies the functionality of the present disclosure. Software 936 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 932, that can contain or store programming for use by or in connection with an instruction execution system, apparatus, or device.

Software 936 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computer system 924 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer system 924 can implement any operating system suitable for operating on the network. Software 936 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

As used herein, the singular forms “a”, “an”, and “the” include the plural reference unless the context clearly dictates otherwise. Reference to “about” a value or parameter or “approximately” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A method for displaying a graphical user interface of a file system for accessing a plurality of files, the method comprising:
receiving the plurality of files from a user;
acquiring, for each file of the plurality of files, one or more representative digital objects associated with the file;
generating a plurality of embeddings by applying a trained machine learning model to data related to the plurality of files or representative digital objects associated with the plurality of files;
obtaining a visual layout of the file system;
projecting the plurality of embeddings in a vector space, such that, for each pair of embeddings in the plurality of embeddings, a separation distance in the vector space between two embeddings in the pair of embeddings corresponds to a degree of similarity of information contained in the respective files represented respectively by the two embeddings;
arranging the plurality of embeddings based on their relative positions within the vector space into which the embeddings are projected; and
displaying the graphical user interface of the file system for accessing the plurality of files by rendering at least some of the representative digital objects associated with the plurality of files based on the arrangement of the plurality of embeddings based on the projection of the plurality of embeddings in the vector space, and based on a packing optimization algorithm that divides a geometric shape of the visual layout into a plurality of containers and packs the representative digital objects into the plurality of containers according to one or more predetermined packing rules, wherein the packing optimization algorithm is configured to group similar files, as indicated by the plurality of embeddings, with one another within the geometric shape

2. The method of claim 1, wherein acquiring the one or more representative digital objects associated with each file comprises providing one or more of the plurality of files to a second trained machine learning model to generate the one or more representative digital objects associated with the one or more files.

3. The method of claim 1, wherein, for each file of the plurality of files, the one or more representative digital objects associated with the file comprise metadata associated with the file.

4. The method of claim 1, wherein, for each file of the plurality of files, the one or more representative digital objects associated with the file comprise one or more representative images associated with the file.

5. The method of claim 4, wherein the one or more representative images associated with each file comprise a plurality of representative images having a plurality of resolutions.

6. The method of claim 1, further comprising:
storing the plurality of files in a file store;
storing the one or more representative digital objects associated with each file of the plurality of files in a digital object store; and
storing the plurality of embeddings in an embedding store,
wherein each file in the file store is associated with one or more digital objects in the digital object store and one or more embeddings in the embedding store.

7. The method of claim 1, wherein obtaining the visual layout comprises obtaining an image that provides an outline of the visual layout.

8. The method of claim 1, wherein obtaining the visual layout comprises obtaining text describing the visual layout.

9. The method of claim 1, wherein the vector space is a two-dimensional vector space, and wherein projecting the plurality of embeddings comprises:
projecting each embedding of the plurality of embeddings into the two-dimensional vector space; and
organizing the plurality of embeddings based on the projections of each embedding.

10. (canceled)

11. The method of claim 1, wherein packing the representative images into the plurality of containers corresponding to the visual layout comprises identifying one or more boundaries of the visual layout.

12. The method of claim 1, comprising:
receiving a search query from the user; and
displaying an updated graphical user interface by updating the render of the representative digital objects based on the search query.

13. The method of claim 12, comprising identifying a first file of the plurality of files that aligns with the search query by comparing the search query to metadata associated with each file of the plurality of files.

14. The method of claim 13, comprising identifying one or more additional files of the plurality of files that align with the search query using the plurality of embeddings.

15. The method of claim 12, wherein the search query indicates a color, a shape, an object, a date, or a location.

16. The method of claim 1, comprising:
receiving user input requesting that the visual layout of the file system be changed to a new visual layout; and
displaying an updated graphical user interface by updating the render of the representative images to the new visual layout.

17. The method of claim 1, comprising:
receiving a user request to share the file system with a second user;
generating one or more datasets for the file system; and
transmitting the one or more datasets to the second user, wherein the one or more datasets are used to generate and display the graphical user interface for the file system on a remote computer system.

18. The method of claim 1, wherein the plurality of files comprises one or more image files, one or more text files, one or more audio files, one or more video files, or combinations thereof.

19. The method of claim 1, wherein obtaining the visual layout of the file system comprises receiving a user input indicative of the visual layout of the file system.

20. The method of claim 1, wherein the visual layout is obtained from a library of predefined visual layouts.

21. A system for displaying a graphical user interface of a file system for accessing a plurality of files, the system comprising one or more processors configured to:
receive the plurality of files from a user;
acquire, for each file of the plurality of files, one or more representative digital objects associated with the file;
generate a plurality of embeddings by applying a trained machine learning model to data related to the plurality of files or representative digital objects associated with the plurality of files
obtain a visual layout of the file system;
project the plurality of embeddings in a vector space such that. for each pair of embeddings in the plurality of embeddings, a separation distance in the vector space between two embeddings in the pair of embeddings corresponds to a degree of similarity of information contained in the respective files represented respectively by the two embeddings;
arranging the plurality of embeddings based on their relative positions within the vector space into which the embeddings are projected; and
display the graphical user interface of the file system for accessing the plurality of files by rendering at least some of the representative digital objects associated with the plurality of files based on the arrangement of the plurality of embeddings based on the projection of the plurality of embeddings in the vector space, and based on a packing optimization algorithm that divides a geometric shape of the visual layout into a plurality of containers and packs the representative digital objects into the plurality of containers according to one or more predetermined packing rules, wherein the packing optimization algorithm is configured to group similar files, as indicated by the plurality of embeddings, with one another within the geometric shape.

22. A non-transitory computer readable storage medium storing instructions for displaying a graphical user interface of a file system for accessing a plurality of files that, when executed by one or more processors of a computer system, cause the computer system to:
receive the plurality of files from a user;
acquire, for each file of the plurality of files, one or more representative digital objects associated with the file;
generate a plurality of embeddings by applying a trained machine learning model to data related to the plurality of files or representative digital objects associated with the plurality of files;
obtain indicative of a visual layout of the file system;
project the plurality of embeddings in a vector space such that, for each pair of embeddings in the plurality of embeddings, a separation distance in the vector space between two embeddings in the pair of embeddings corresponds to a degree of similarity of information contained in the respective files represented respectively by the two embeddings;
arranging the plurality of embeddings based on their relative positions within the vector space into which the embeddings are projected; and
display the graphical user interface of the file system for accessing the plurality of files by rendering at least some of the representative digital objects associated with the plurality of files based on the arrangement of the plurality of embeddings based on the projection of the plurality of embeddings in the vector space, and based on a packing optimization algorithm that divides a geometric shape of the visual layout into a plurality of containers and packs the representative digital objects into the plurality of containers according to one or more predetermined packing rules, wherein the packing optimization algorithm is configured to group similar files. as indicated by the plurality of embeddings, with one another within the geometric shape.

23. The method of claim 12, wherein:
receiving the search query from the user comprises receiving an indication of a target file of the plurality of files;
updating the render of the representative images based on the search query comprises automatically arranging at least some of the representative digital objects in accordance with a plurality of axes of the visual layout;
a first axis of the plurality of axes corresponds to a first type of file data, and digital objects are arranged along the first axis in accordance with similarity between represented files and the target file with respect to the first type of file data; and
a second axis of the plurality of axes corresponds to a second type of file data, and digital objects are arranged along the second axis in accordance with similarity between represented files and the target file with respect to the second type of file data.
